(19) United States
(12) Patent Application Publication
(10) Pub. No.: US 2011/0202573 A1
(43) Pub. Date: Aug. 18, 2011

(54) CLINICAL HYPER-REVIEW AND RECONCILIATION SYSTEM

(76) Inventor: Mark Golino, Sanford, FL (US)

(21) Appl. No.: 12/774,206

(22) Filed: May 5, 2010

Related U.S. Application Data
(60) Provisional application No. 61/303,879, filed on Feb. 12, 2010.

(51) Int. Cl. G06F 17/30

(52) U.S. Cl. 707/802; 707/E17.044

(57) ABSTRACT

According to some embodiments, an apparatus and a method are provided to receive an input associated with a patient encounter, extract a plurality of keywords and at least one sentence from the input. The at least one sentence is associated with at least one of the plurality of keywords. The keywords and the at least one associated sentence are stored and the keywords are displayed. Moreover, a plurality of indications is received. Each of the plurality of indications is associated with a respective one of the plurality of keywords.

### CROSS-REFERENCE TO RELATED APPLICATION

This application claims priority to the provisional patent application filed Feb. 12, 2010, having Application Serial Number 61/303,879 entitled CHRRP (Coder Hyper Review and Reporting Platform), the contents of which are herein incorporated by reference for all purposes.

### BACKGROUND

A charge slip (i.e., a super bill or charge ticket) is a paper or electronic form that is filled out by a provider (i.e., a medical practitioner or a clinician) associated with a patient. The charge slip indicates what services and/or diagnostic tests have been performed on or for the patient. Once filled out, the charge slip is forwarded to charge entry personnel for review regarding billing and reimbursement.

Typically, the provider follows up the charge slip with a patient encounter. The patient encounter may include hand written notes of the provider's encounter with a patient or dictation associated with the patient. The patient encounter will also be forwarded to charge entry personnel who compare the charge slip with the patient encounter to verify that the charge slip was correctly filled out and that all services performed by the provider have been billed. However, requiring charge entry personnel to review each patient encounter, and compare the patient encounter with a charge slip, is time consuming and costly. Moreover, numerous potentially billable services that have been performed by the provider are typically missed during examination of the patient encounter and are therefore not billed or the patient may be possibly overbilled and thus request a charge back.

### SUMMARY

According to some embodiments, an apparatus, a system, and a method are provided to receive an input associated with a patient encounter, extract a plurality of keywords and at least one sentence from the input. The at least one sentence is associated with at least one of the plurality of keywords. The keywords and the at least one associated sentence are stored and the keywords are displayed. Moreover, a plurality of indications is received. Each of the plurality of indications is associated with a respective one of the plurality of keywords.

### BRIEF DESCRIPTION OF THE DRAWINGS

FIG. 1 illustrates a method according to some embodiments.

FIG. 2 illustrates an embodiment of a screen capture.

FIG. 3 illustrates an embodiment of a screen capture.

FIG. 4 illustrates an embodiment of a screen capture.

FIG. 5 illustrates an embodiment of a screen capture.

FIG. 6 illustrates an embodiment of a screen capture.

FIG. 7 illustrates an apparatus according to some embodiments.

FIG. 8 illustrates a system according to some embodiments.

FIG. 9 illustrates an embodiment of a screen capture.

### DETAILED DESCRIPTION

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

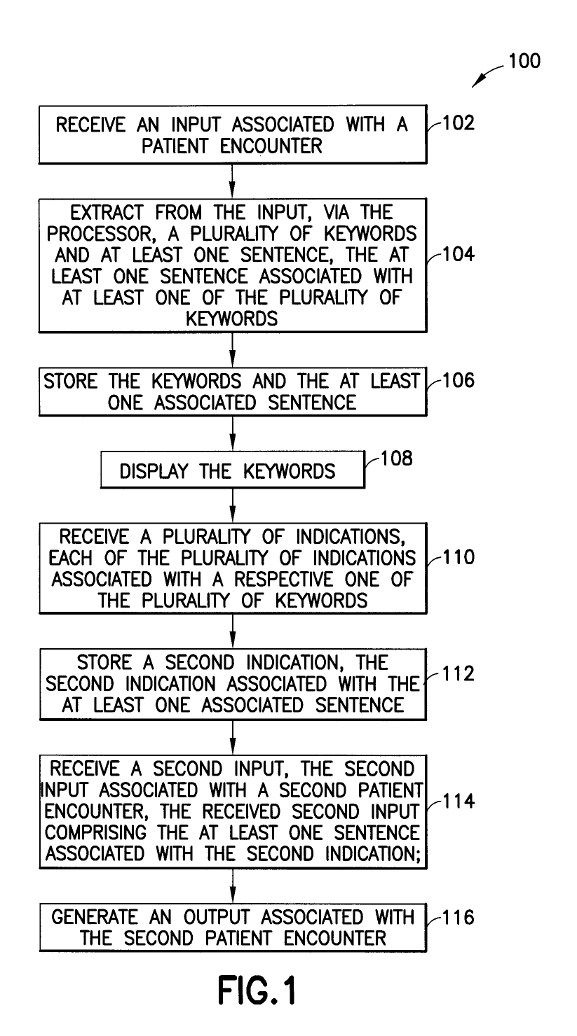

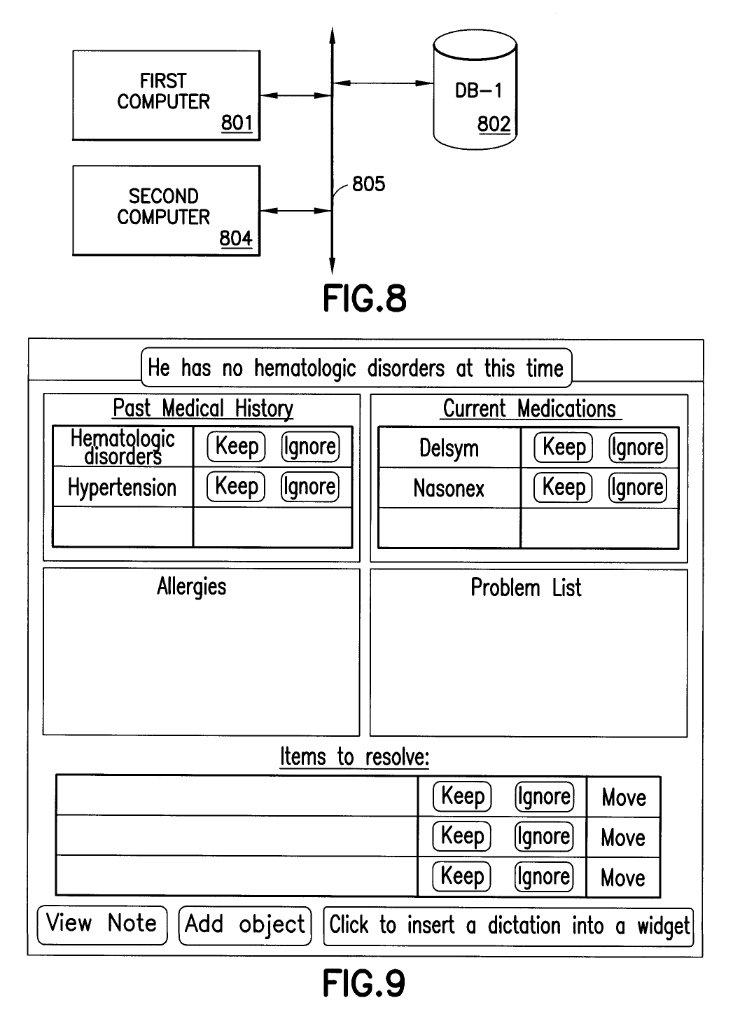

FIG. 1 illustrates a method 100 according to some embodiments. The method of FIG. 1 may be performed by, but is not limited to, an apparatus such as that described with respect to FIG. 7 or a system such as that described with respect to FIG. 8.

At 102, an input associated with a patient encounter is received. In some embodiments, the input is in a form of a scanned document, an electronic document, or an electronic file. According to some embodiments, the input relates to an unstructured document associated with a patient encounter.

For illustrative purposes, and to aid in understanding features of the specification, an example will now be introduced. This example is not intended to limit the scope of the claims. For example, Mr. Jones Greg visits his physician after falling and having symptoms of not being capable of putting pressure on his leg. The physician runs a series of tests on Mr. Greg, including an X-ray, that indicate a fracture and a sprain as a result of the fall but the Physician also discovers that Mr. Greg suffers from osteoarthritis. After seeing Mr. Greg, the physician may type free text or dictate a patient encounter into a dictation machine or a computer using speech recognition software which transcribes the patient encounter into an electronic file. Furthermore, the physician fills out a charge slip associated with Mr. Greg. The patient encounter (e.g., an electronic file) is received at a system or apparatus capable of inputting the patient encounter and the charge slip is forwarded to charge entry personnel.

Next, at 104, a plurality of keywords and at least one sentence are extracted from the input via a processor, the at least one sentence is associated with at least one of the plurality of keywords. In some embodiments, a keyword is any word, phrase, or combination of alphanumeric symbols.

In some embodiments, the processor automatically scans the electronic file based on a mix of clinical and non-clinical keywords. For example, the processor may be associated with a scanning engine that comprises a clinically oriented Natural Language Processing Engine to parse unstructured data to locate keywords, phases, and clinical data. Scanning for keywords is based on an industry specific database that comprises a plurality of known keywords. For example, the industry specific database may comprise, but is not limited to, a medical specific database or a legal specific database.

Continuing with the above example, the processor may scan the electronic file associated with Mr. Greg and may determine the following keywords: X-ray, Radiographs, Synvisc, Sprain, Fracture, Crutch Training, Depomedrol, Herniation, I & D, and Injection.

Furthermore, the processor determines at least one sentence that is associated with at least one of the plurality of keywords. In some embodiments, the processor may determine each sentence that has at least one determined keyword from the input. For example, and continuing with the above example, each sentence that contains at least one of keywords: X-ray, Radiographs, Synvisc, Sprain, Fracture, Crutch Training, Depomedrol, Herniation, I & D, and Injection will be determined. Therefore, sentences such as “The patent shows signs of Osteoarthritis and I recommend treatment using Synvisc or Depomedrol”, “The X-ray of the patient indicates a sprain to his right ankle and a hairline fracture to his right tibia”, and “The patient was provided with crutch training” will be stored. Each sentence is associated with its one or more particular keywords.

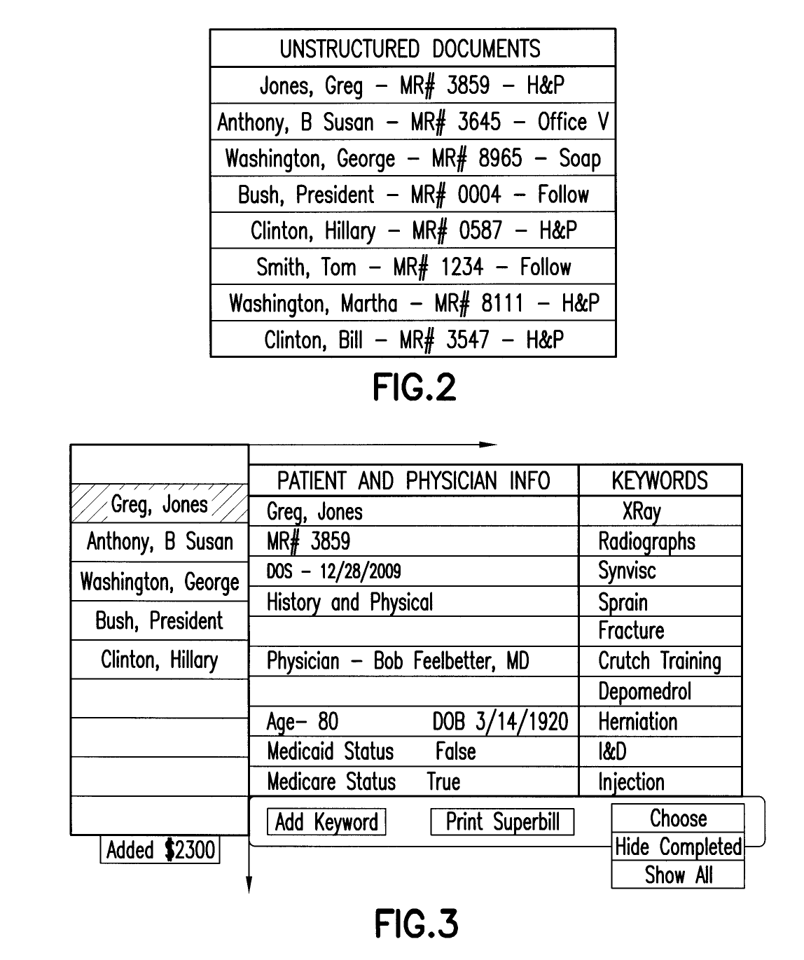

The keywords and the at least one associated sentence are stored at 106. In some embodiments, the keywords and the at least one associated sentence are stored in a database. Next, at 108, the keywords are displayed. In some embodiments, the keywords are displayed on a screen to charge entry personnel. For example, and now referring to FIG. 2, an embodiment of a screen shot that is presented to charge personnel is illustrated.

As illustrated in FIG. 2, a list of unstructured documents is presented. In some embodiments, each unstructured document is associated with a patients name, a medical record number, and an office visit type indicator. While the aforementioned elements associated with an unstructured document are displayed to charge entry personnel in the present embodiment, any amount of information may be presented.

Continuing with the above example, and as illustrated in FIG. 2, an unstructured document associated with “Jones, Greg—MR#3859—H & P” is displayed. Referring now to FIG. 3, once an unstructured document is selected, a detail screen may display a plurality of information associated with the unstructured document. The plurality of information may include, but is not limited to, the plurality of keywords, a date of birth of the patient, an age of the patient, and a name of the physician. As illustrated in FIG. 3, the keywords extracted from the unstructured document are listed in a column however, the keywords may be stored in a queue and displayed in any format that allows charge entry personnel to view the plurality of keywords.

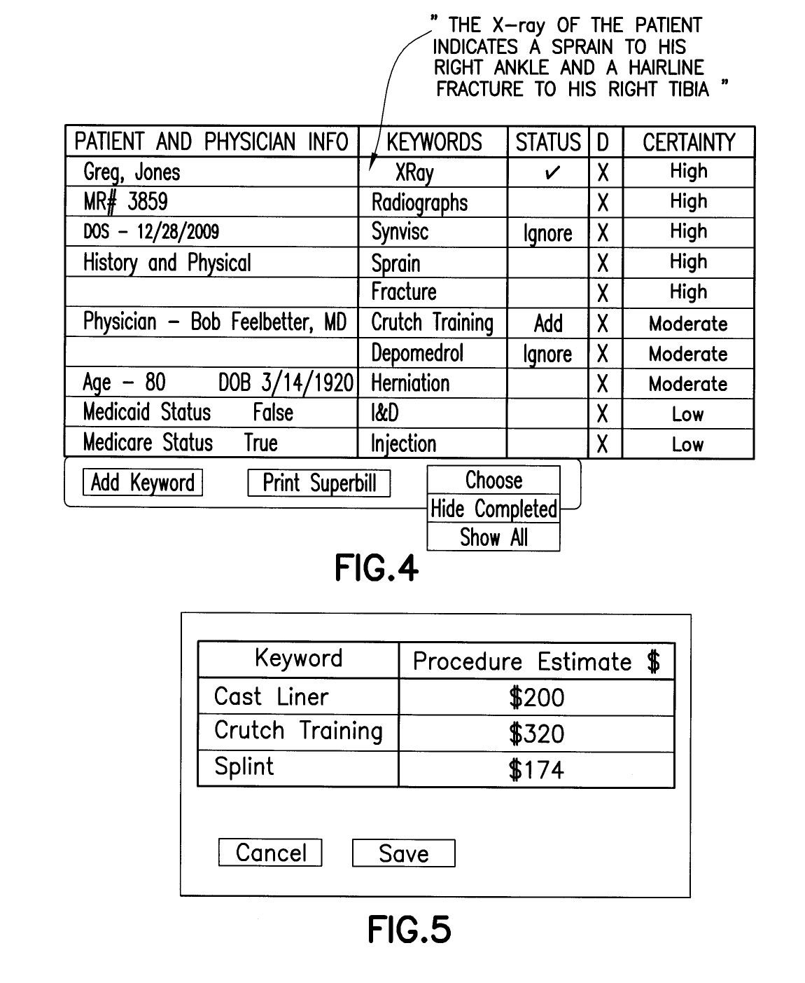

To further aid in an examination of a charge slip based on the plurality of keywords, and now referring to FIG. 4, a keyword is selected and one or more sentences associated with the keyword are presented to the charge entry personnel. In some embodiments, a keyword is selected by, but not limited to, highlighting the keyword or moving a mouse cursor over the keyword.

Referring back to FIG. 1, a plurality of indications is received at 110 where each of the plurality of indications is associated with a respective one of the plurality of keywords. The plurality of indications is associated with an examination of a charge slip based on the plurality of keywords. For example, in some embodiments, the plurality of indications may comprise a first indication that subject matter associated with one of the plurality of keywords has been included in the charge slip, a second indication that subject matter associated with the one of the plurality of keywords has been added to the charge slip, and/or a third indication that the subject matter associated with the keyword is neither included in the charge slip nor will be added to the charge slip.

Charge entry personnel compare each keyword of the plurality of keywords with an associated charge slip to determine if any subject matter that could have been billed was not entered on the charge slip. When the charge entry personnel review each keyword such as those illustrated in FIG. 4, the charge entry personnel may view the sentence and/or sentences associated with each keyword to determine if the subject matter associated with that keyword is “already on” the charge slip, needs to be “added to” the charge slip, or should be “ignored”. Therefore, an indicator of “already on”, “added to”, or “ignored” is entered for each keyword. In some embodiments, charge entry personnel may manually adds additional keywords if the charge entry personnel or a manager determine that a keyword is missing. The entered status may then be stored in a database to allow for reporting of bills or for potential audits.

Continuing with the above-example, a charge slip associated with Mr. Greg may indicate an X-ray, treatment for a sprain, and treatment for a fracture. When charge entry personnel compare the charge slip for Mr. Greg with the keyword X-ray, the charge entry personnel may view the sentences associated with the keyword X-ray. When the keyword X-ray is selected, a sentence of “The X-ray of the patient indicates a sprain to his right ankle and a hairline fracture to his right tibia” is displayed as illustrated in FIG. 4. The charge entry personnel can then enter in “already on” as a status since the X-ray has already been added to the charge slip. Likewise, sentences associated with keywords Sprain and Fracture may yield the same sentence as above and would require a status of “already on”. When the charge entry personnel examine the keyword Synvisc a sentence of “The patient shows signs of osteoarthritis and I recommend treatment using Synvisc or Depomedrol” is displayed. The charge personnel may determine that neither Synvisc nor Depomedrol were dispensed and thus these keywords are indicated as “ignored”. Moreover, when the key-phrase “crutch training” is examined, the sentence “The patient was provided with crutch training” is displayed. The charge entry personnel may determine that crutch training was not entered on the charge slip and, since crutch training was provided to the patient, it should be billed. Therefore, an entry of “added to” is entered. Some embodiments may facilitate the process of comparing a charge ticket to an associated patient encounter.

Furthermore, each “added to” entry is associated with a monetary value as illustrated in FIG. 5. For example, an organization is able to determine a cost savings by adding the monetary values for all “added to” entries. As illustrated in FIG. 5, a monetary value associated with crutch training is $320. Therefore, if an “added to” value is associated with crutch training, then additional revenue of $320 is realized. Furthermore, if crutch training had been improperly added to a charge slip, an “ignored” entry for the crutch training may eliminate a charge back of $320.

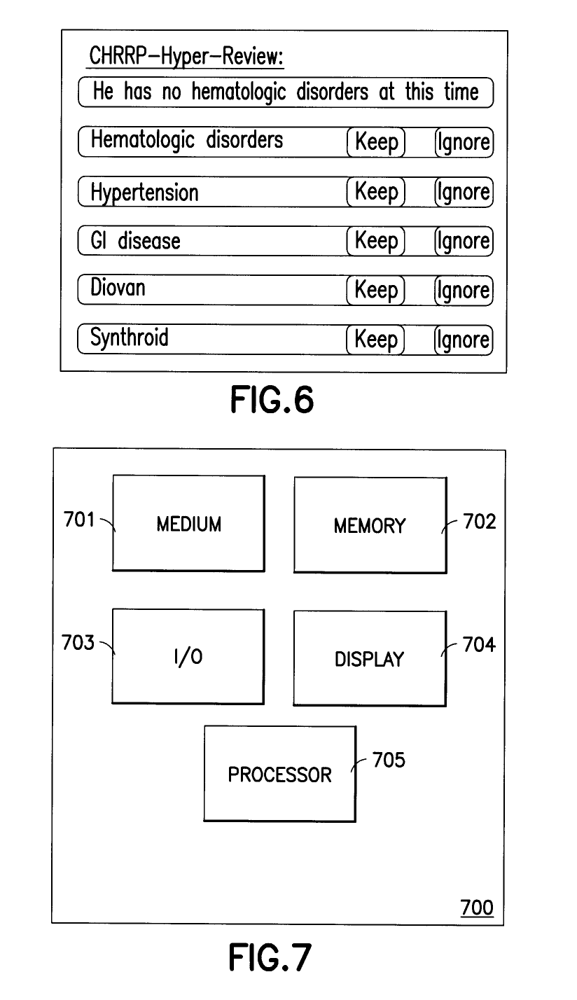

Now referring to FIG. 6, an embodiment of a graphical user interface (“GUI”) is illustrated. In some embodiments, the GUI of FIG. 6 may represent a provider interface to a system.

Referring back to FIG. 1, at 112 a second indication is stored, where the second indication is associated with the at least one associated sentence. In some embodiments, a provider may desire to review a patient encounter and approve the extracted keywords and associated sentences of the patient encounter. The provider can access a system to review the unstructured document associated with a patient. As illustrated in FIG. 6, the provider views each keyword and its associated sentence and indicates an approval (e.g., “keep”) or disapproval (e.g., “ignore”). In some embodiments, a provider views a sentence associated with a keyword by highlighting the keyword, moving a mouse cursor over the keyword, or speaking the keyword into a microphone. In some embodiments, the provider bases a determination to keep or ignore a sentence on an accuracy and/or relevancy of a patient encounter/health history. When a keyword and associated sentence are approved, an indication is stored in a database where the indication is associated with the associated sentence. In some embodiments, the indication associated with the sentence indicates that the sentence will be available for reuse to create future patient encounters in the form of an unstructured document and/or Continuity of Care Document (CCD). Each sentence may be an object that is written to a database or other medical based system. Examples of sentence objects may comprise “He has no hematologic disorder.”, “She has no GI disease.”, “She has hypertension and high blood pressure.”, or “He takes Diovan for hypertension and he is also on Synthroid.” According to some embodiments, FIG. 9 illustrates a screen provided to a physician or a provider.

By storing sentence objects, a provider, instead of dictating a patient encounter, can select sentence objects from a list of available keywords and sentence objects. The provider can select a plurality of sentence objects that will be stored in an unstructured document and/or Continuity of Care Document (CCD) to represent a patient encounter. For example, and continuing with the above example, the provider may have indicated that the sentence “The patent shows signs of osteoarthritis and I recommend treatment using Synvisc or Depomedrol” will be used as a sentence object. Therefore, when a next patient with similar symptoms is examined, a patient encounter may include the sentence object “The patent shows signs of osteoarthritis and I recommend treatment using Synvisc or Depomedrol” that the provider has selected from a list of sentence objects.

Therefore, at 114 of FIG. 1, when a second input is received, where the second input is associated with a second patient encounter, the received second input will comprise the at least one sentence associated with the second indication, and an output associated with the second patient encounter will be generated at 116. Some embodiments may maintain an accurate record of a patient encounter while reducing a cost of transcription services.

Now referring to FIG. 7, an embodiment of an apparatus 700 is illustrated. In some embodiments, the apparatus 700 may comprise a desktop computer, a cell phone, a personal data assistant, or a laptop computer. The apparatus may execute a method, such as, but not limited to, the method of FIG. 1.

The apparatus 700 may comprise a medium 701, a memory 702, an input/output port 703, a display 704, and a processor 705.

The medium 701 may comprise any computer-readable medium that may store processor-executable instructions to be executed by the processor 701. For example, the medium 701 may comprise, but is not limited to, a compact disk, a digital video disk, flash memory, optical storage, random access memory, read only memory, or magnetic media.

The memory 702 may store, for example, applications, programs, procedures, and/or modules that store instructions to be executed. The memory 702 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

The input/output port 703 may comprise any port that allows peripheral devices or external elements to be connected to the apparatus 700. In some embodiment, the input/output port may comprise, but is not limited to, a universal serial bus (USB) port.

The display 704 may display alphanumeric characters and graphics. In some embodiments, the display 704 may comprise a plurality of backlight lamps. In some embodiments, the display 704 is a LCD display.

The processor 705 may include or otherwise be associated with dedicated registers, stacks, queues, etc. that are used to execute program code and/or one or more of these elements is shared there between.

Now referring to FIG. 8, an embodiment of a system 800 is provided. The system 800 may comprise a first computer 801, a second computer 804, and a database 802.

The first computer 801 and the second computer 804 may each comprise an apparatus such as that described with respect to FIG. 7. In some embodiments, the first computer 801 may communicate with the second computer 804 via a network 805. In some embodiments, a provider is able to export an unstructured document from the first computer 801 to the second computer 804 in a format that can be imported into the second computer 804 such as, but not limited to, a rich text format or a Microsoft Word format.

The database 802 may comprise any database system this is, or will be known. In some embodiments, the database 802 may be comprised of, but not limited to, non-volatile memory, flash memory, magnetic media, optical media, read only memory, or any other available media.

In some embodiments, the database 802 is a central database that stores data associated with patients such as, but not limited to, keywords, sentences, and unstructured documents. In some embodiments, the database 802 may be associated with an HIS system, EMR, or PM.

The several embodiments described herein are solely for the purpose of illustration. Persons in the art will recognize from this description that other embodiments may be practiced with modifications and alterations, limited only by the claims.

What is claimed is:

1. A method comprising:
receiving an input associated with a patient encounter;
extracting, via a processor, a plurality of keywords and at least one sentence from the input, the at least one sentence associated with at least one of the plurality of keywords;
storing the keywords and the at least one associated sentence;
displaying the keywords; and
receiving a plurality of indications, each of the plurality of indications associated with a respective one of the plurality of keywords.

2. The method of claim 1, further comprising:
storing a second indication, the second indication associated with the at least one associated sentence;
receiving a second input, the second input associated with a second patient encounter, the received second input comprising the at least one sentence associated with the second indication; and
generating an output associated with the second patient encounter.

3. The method of claim 1, wherein the plurality of indications comprises a plurality of statuses based on a comparison between a charge slip and the input associated with the patient encounter.

4. The method of claim 3, wherein the plurality of indications comprise a first indication that subject matter associated with one of the plurality of keywords has been included in the charge slip, a second indication that subject matter associated with the one of the plurality of keywords has been added to the charge slip, and a third indication that the subject matter associated with the keyword is neither included in the charge slip nor will be added to the charge slip.

5. The method of claim 1, wherein the keywords and associated sentence are stored in a database.

6. The method of claim 5, wherein a monetary value is associated with each of the plurality of keywords stored in the database.

7. An apparatus comprising:
a processor; and
a computer-readable medium comprising processor-executable instructions that when executed by the processor cause the processor to:
receive an input associated with a patient encounter;
extract a plurality of keywords and at least one sentence from the input, the at least one sentence associated with at least one of the plurality of keywords;
storing the keywords and the at least one associated sentence;
display the keywords; and
receive a plurality of indications, each of the plurality of indications associated with a respective one of the plurality of keywords.

8. The apparatus of claim 7, further comprising processor-executable instructions to:
store a second indication, the second indication associated with the at least one associated sentence;
receive a second input associated, the second input associated with a second patient encounter, the received second input comprising the at least one sentence associated with the second indication; and
generate an output associated with the second patient encounter.

9. The apparatus of claim 7, wherein the plurality of indications comprises a plurality of statuses based on a comparison between a charge slip and the input associated with the patient encounter.

10. The apparatus of claim 9, wherein the indications comprise a first indication that subject matter associated with one of the plurality of keywords has been included in the charge slip, a second indication that subject matter associated with the one of the plurality of keywords has been added to the charge slip, and a third indication that the subject matter associated with the keyword is neither included in the charge slip nor will be added to the charge slip.

11. The apparatus of claim 7, wherein the keywords and associated sentence are stored in a database.

12. The apparatus of claim 11, wherein a monetary value is associated with each of the plurality of keywords stored in the database.

13. A system comprising:
a database;
a processor; and
a computer-readable medium comprising processor-executable instructions that when executed by the processor cause the processor to:
receive an input associated with a patient encounter;
extract a plurality of keywords and at least one sentence from the input, the at least one sentence associated with at least one of the plurality of keywords;
storing the keywords and the at least one associated sentence in the database;
display the keywords; and
receive a plurality of indications, each of the plurality of indications associated with a respective one of the plurality of keywords.

14. The system of claim 13, further comprising processor-executable instructions to:
store a second indication, the second indication associated with the at least one associated sentence;
receive a second input associated, the second input associated with a second patient encounter, the received second input comprising the at least one sentence associated with the second indication; and
generate an output associated with the second patient encounter.

15. The system of claim 13, wherein the plurality of indications comprises a plurality of statuses based on a comparison between a charge slip and the input associated with the patient encounter.

16. The system of claim 15, wherein the indications comprise a first indication that subject matter associated with one of the plurality of keywords has been included in the charge slip, a second indication that subject matter associated with the one of the plurality of keywords has been added to the charge slip, and a third indication that the subject matter associated with the keyword is neither included in the charge slip nor will be added to the charge slip.

17. The system of claim 13, wherein a monetary value is associated with each of the plurality of keywords stored in the database.
